(19) United States
(12) Patent Application Publication
(10) Pub. No.: US 2013/0209753 A1
(43) Pub. Date: Aug. 15, 2013

(54) LAMINATED ROLLING PAPERS

(71) Applicant: Amer M. Idheileh, Christiansted, VI (US)

(72) Inventor: Amer M. Idheileh, Christiansted, VI (US)

(21) Appl. No.: 13/755,344

(22) Filed: Jan. 31, 2013

Related U.S. Application Data
(60) Provisional application No. 61/598,830, filed on Feb. 14, 2012.

(51) Int. Cl. B32B 9/06; B32B 7/04; B32B 7/12; B32B 15/12

(52) U.S. Cl. CPC B32B 9/06; B32B 15/12; B32B 7/045; B32B 7/12
USPC 428/194; 428/535; 428/464; 428/211.1

(57) ABSTRACT

A laminated rolling paper includes a raw tobacco leaf adhered to a cigarette paper to provides a natural blunt wrap that provides consumers with a more natural method to roll their own blunt cigarette or cigar. The natural blunt has a construction that enables the end user to roll a more natural smoking product, which will burn more smoothly and more slowly than conventional cigarette papers, and results in a taste that is far superior to conventional smoking products and methods.

### CROSS-REFERENCE TO RELATED APPLICATION

This U.S. non-provisional patent application claims the benefit of co-pending U.S. provisional patent application Ser. No. 61/598,830, filed on Feb. 14, 2012 by the same inventor, which is incorporated herein in its entirety.

### FIELD OF THE INVENTION

The present disclosure generally relates to smokable product rolling paper. More particularly, the present disclosure relates to a rolling paper fabricated having a rolling paper substrate laminated to a tobacco leaf or the like.

### BACKGROUND OF THE INVENTION

Rolling papers, sometimes referred to as cigarette papers, are small sheets, rolls, or leaves of paper that are packaged and sold for rolling smokable product into cigarettes. The rolling process is accomplished either by hand or using a rolling machine. When rolling a cigarette, one fills the rolling paper with tobacco, cannabis, hash, cloves, damiana, and the like.

Rolling paper is offered for those people who prefer to roll their own cigarettes, where the person can customize the cigarette using any blend of smokable product, and roll the cigarette into any shape, size, and form they choose.

Rolling papers are most commonly fabrication from wood pulp, hemp, flax, rice straw, esparto (in rare instances), and the like. The common form factor of a single rolling paper is a long rectangle having a narrow strip of glue or gum all along one of the long edges. Longer, rice-based rolling papers are also often used to make spliffs or used for rolling longer cigarettes. Rolling papers are also called skins or rollies (a term which can also mean the hand-rolled cigarettes themselves), but the term skinning up usually only refers to the act of rolling a spliff. Newer rolling papers are available in various flavors.

Rolling papers are sold in lengths between 70 mm through 110 mm and a range of widths. Most manufacturers sell rolling paper in the USA using the designations of 1 (Single wide), 1¼ size, 1½ size and “Doublewide” (2 or 2.0). However, within the industry, these designations have slightly different meanings, wherein the size references are not definitive but moreover a general size. Across the various brands of cigarette papers the actual widths of the papers using these designations vary greatly. For example, the 1¼ designation is used with papers having widths ranging from about 1.7 inches to 2 inches, and the 1½ designation is used with papers having widths ranging from around 2.4 to 3 inches. However the length of these papers is always 78 mm (+/−1 mm). It is noted that the 1¼ size is also referred to as “Spanish Size” or “French” rolling paper in some parts of the world.

While a 1¼ sized paper is not exactly 25% larger than a 1 (single wide) paper, there is meaning to these size names. A better way to describe these accurately is that a 1¼ size is designed to roll a cigarette that contains about 25% more filler than a single wide paper. Similarly a 1½ size paper is designed to roll a cigarette that contains about 50% more than a single wide paper. A 1¼ size paper is larger than a 1 (single wide) paper and naturally a 1½ size paper is larger than a 1¼ size paper, and a double wide is larger than a 1½ size paper.

King Size is another multi-meaning term. While a King Size cigarette is typically 84 mm long, a King Size rolling paper is either 100 mm or 110 mm in length.

Many smokers prefer a more natural smoking experience. Unfortunately, the vast majority of available rolling substrates revolve around homogenized papers and the like, which do not provide such consumers with an optimal smoking experience. Such smokers are left with very few alternatives, including opening up a cigar and re-rolling, using the binder and wrapper, with their desired tobacco blend or mix. There has been a long felt but unmet desire in the smoking community for a more natural blunt wrap for rolling a cigarette or a cigar. It would be particularly desirable to provide such a wrap that will burn smoother and more slowly, and provide a far superior taste than existing products and methods.

The present invention provides a natural blunt wrap, in the form of a cigarette paper and raw tobacco leaf laminate, which overcomes the aforementioned disadvantages, drawbacks and limitations of existing smoking products and methods.

### SUMMARY OF THE INVENTION

The basic inventive concept laminates two or more different substrate materials together forming a laminated rolling paper.

A first aspect of the present invention provides a laminated rolling paper comprising:

a first rolling paper substrate sized, shaped, and of a weight consistent with established rolling paper properties;

a second rolling paper substrate fabricated of a natural, smokable product; and

a bonding composition,

wherein the first rolling paper substrate and the second rolling paper substrate are laminated by the bonding composition.

A second aspect of the present invention, the first rolling paper substrate is fabricated of one of: wood pulp, hemp, flax, rice straw, esparto (in rare instances), and the like.

In yet another aspect, the first rolling paper substrate is fabricated of one of paper, homogenized paper, homogenized tobacco-impregnated paper, homogenized tobacco.

In yet another aspect, the second rolling paper substrate is fabricated of a natural smokable product.

In yet another aspect, the second rolling paper substrate is fabricated of a natural tobacco leaf.

In yet another aspect, the bonding agent is applied to at least one of a first rolling paper substrate bonding surface and a second rolling paper substrate bonding surface.

In yet another aspect, the bonding agent is applied to opposite surfaces of a bonding layer, wherein the bonding layer is placed between the first rolling paper substrate material and the second rolling paper substrate material.

In yet another aspect, the bonding composition is a non-toxic composition.

In yet another aspect, the laminated rolling paper further comprises a moisture activated gum strip applied in a form of a strip located parallel and adjacent to one longitudinal edge.

In yet another aspect, the natural smokable product is a tobacco leaf.

In yet another aspect, the adhesive utilized between the rolling paper and the natural smokable product is provided in a form of a sheet.

In yet another aspect, at least one of the first rolling paper substrate and the second rolling paper substrate is impregnated with a flavor.

In yet another aspect, a smokable product is placed upon the rolling paper and the rolling paper is rolled into a form of a cigarette.

These and other advantages of the invention will be further understood and appreciated by those skilled in the art by reference to the following written specification, claims and appended drawings.

### BRIEF DESCRIPTION OF THE DRAWINGS

The invention will now be described, by way of example, with reference to the accompanying drawings, where like numerals denote like elements and in which:

FIG. 1 presents an isometric exploded assembly view of a first exemplary laminated rolling paper;

FIG. 2 presents an isometric view of the laminated rolling paper originally introduced in FIG. 1;

FIG. 3 presents a top plan view of the laminated rolling paper originally introduced in FIG. 1;

FIG. 4 presents an isometric view illustrating a rolling process using the laminated rolling paper originally introduced in FIG. 1;

FIG. 5 presents an isometric exploded assembly view of a second exemplary laminated rolling paper; and

FIG. 6 presents an isometric view of the laminated rolling paper originally introduced in FIG. 5.

Like reference numerals refer to like parts throughout the various views of the drawings.

### DETAILED DESCRIPTION OF THE INVENTION

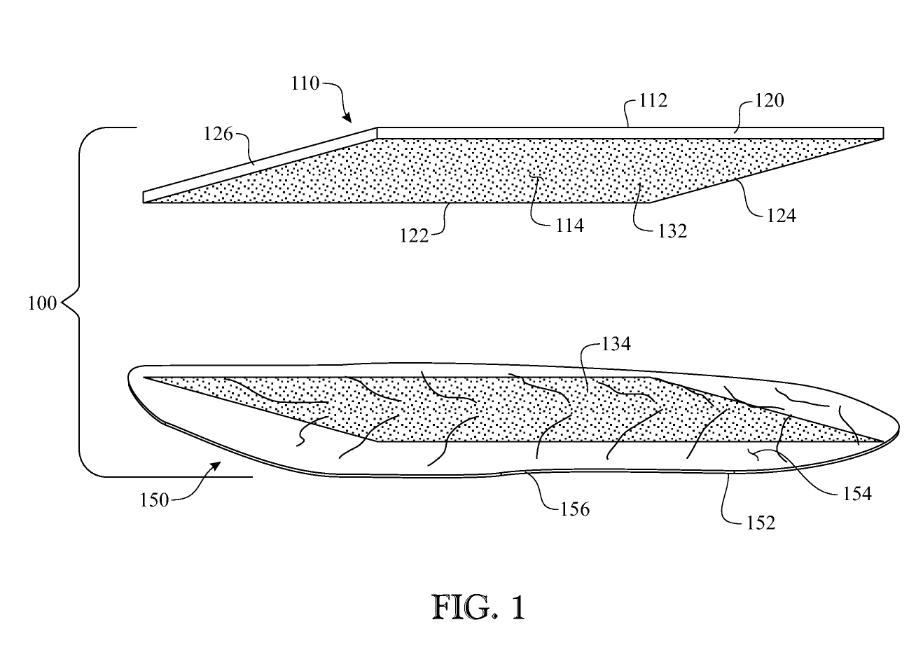

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

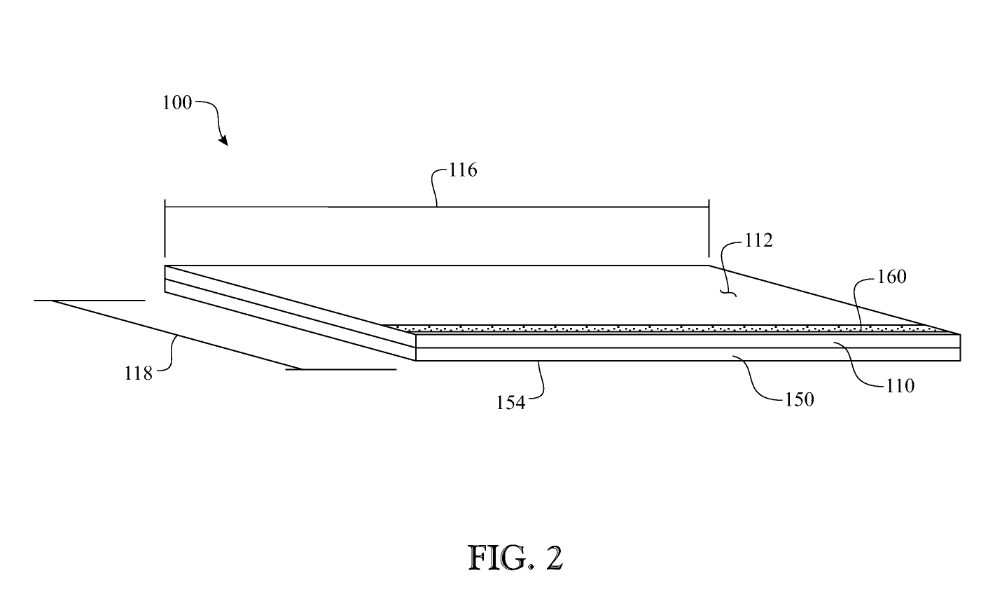

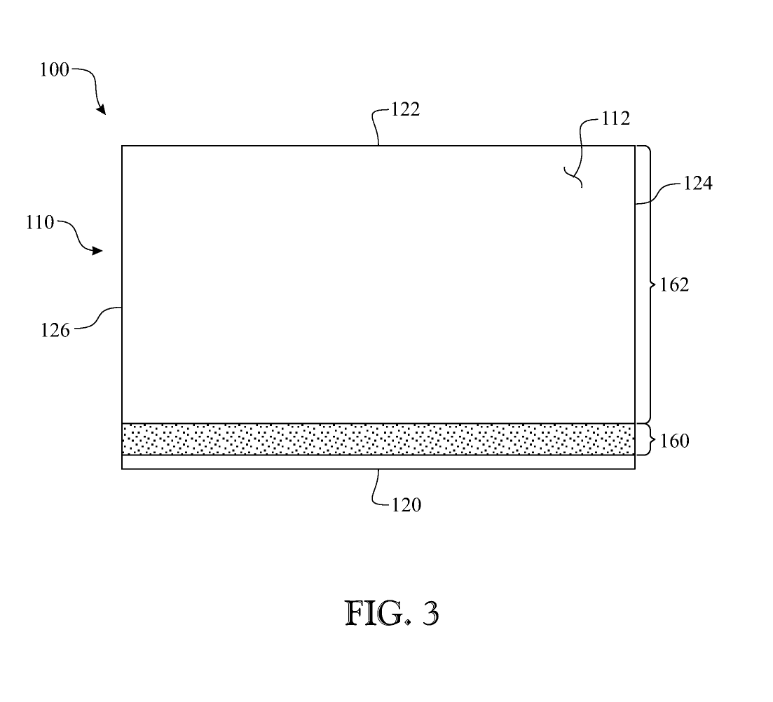

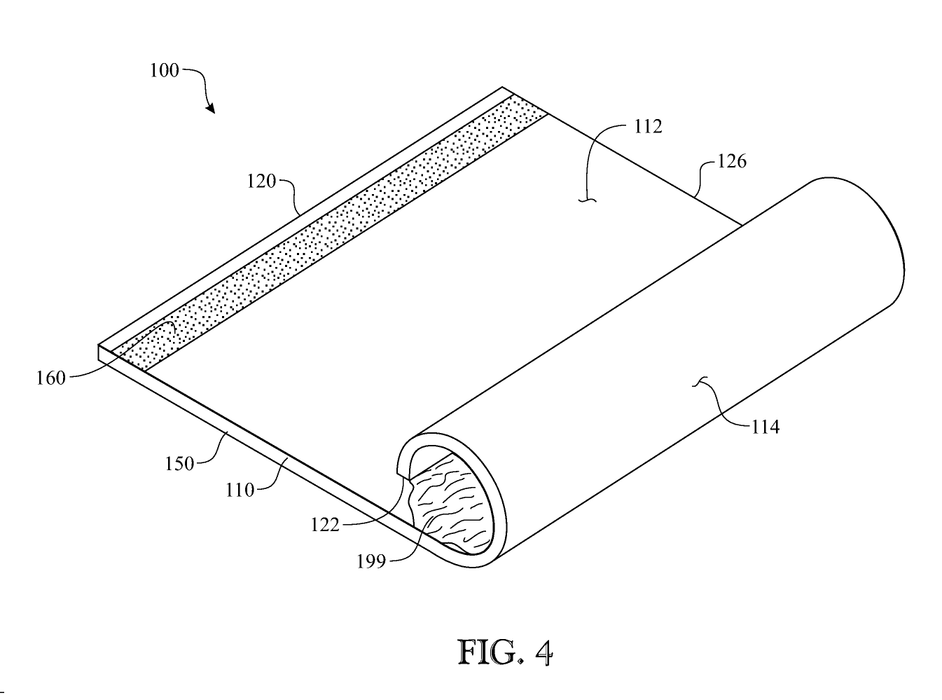

An exemplary first embodiment of the present invention is referred to as a laminated rolling paper 100, which is illustrated in FIGS. 1 through 3, with an exemplary application of the laminated rolling paper 100 illustrated in FIG. 4. The laminated rolling paper 100 is fabricated by laminating a rolling paper substrate 110 (a first rolling paper substrate) and a tobacco leaf 150 (a second rolling paper substrate) to one another.

The rolling paper substrate 110 is fabricated of a wood pulp, hemp, flax, rice straw, a tobacco leaf, esparto (in rare instances), and the like. Alternatively, the rolling paper substrate 110 can be fabricated of homogenized paper, homogenized tobacco-impregnated paper, homogenized tobacco, and the like.

The application described herein is particularly directed towards a rolling paper substrate 110 that is fabricated of a homogenized paper. The rolling paper substrate 110 can be defined as a planar sheet of flexible, combustible material having an smokable substance receiving surface 112 located on a first side and an exterior rolled surface 114 located on a second, opposite side; the surfaces bound by a continuous peripheral edge defined by a first longitudinal rolling paper edge 120, a second longitudinal rolling paper edge 122, a first lateral rolling paper edge 124 and a second lateral rolling paper edge 126. The two longitudinal rolling paper edges 120, 122 define a longitudinal dimension 116 of the rolling paper substrate 110 and are preferably parallel to one another. The two transverse rolling paper edges 124, 126 define a transverse dimension 118 of the rolling paper substrate 110 and are also preferably parallel to one another. The two longitudinal rolling paper edges 120, 122 are preferably perpendicular to the two transverse rolling paper edges 124, 126.

In the exemplary embodiment, a moisture activated gum strip 160 is disposed upon a portion of the smokable substance receiving surface 112. The moisture activated gum strip 160 covers a strip of the smokable substance receiving surface 112 adjacent to the first longitudinal rolling paper edge 120. The moisture activated gum strip 160 is well known in the industry. The moisture activated gum strip 160 can be flavor-free and/or scent-free to minimize any adverse effects of the gum composition on the smoking experience. Alternatively, the moisture activated gum strip 160 can be enhanced by adding a flavoring and/or scent thereto to enhance the smoking experience.

The rolling paper substrate 110 is sized to meet the common, standard rolling paper dimensions. The exemplary rolling paper substrate 110 is dimensionally referenced by the longitudinal dimension 116 (length) and transverse dimension 118 (width). The common form factor of a single rolling paper is a long rectangle having a narrow strip of glue or gum (moisture activated gum strip 160) along one of the long edges. Rolling papers are offered in standard lengths between 70 mm through 110 mm and a range of widths. The width of the rolling papers is commonly referenced using the designations of 1 (Single wide), 1¼ size, 1½ size and “Doublewide” (2 or 2.0). The 1¼ designation generally refers to papers having widths ranging from about 1.7 inches to 2 inches. The 1½ designation generally refers to papers having widths ranging from around 2.4 to 3 inches. The typical length of rolling papers is 78 mm, with a tolerance of +/−1 mm.

It is noted that the rolling paper substrate 110 may be flavored to enhance the smoking experience.

The tobacco leaf 150 is fabricated of any combustible, natural smokable leaf having a suitable size and thickness, such as a tobacco leaf and the like. The tobacco leaf 150 can be referenced by a tobacco leaf exposed surface 152 and an opposite tobacco leaf bonding surface 154, wherein the tobacco leaf exposed surface 152 and tobacco leaf bonding surface 154 are bound by a tobacco leaf edge 156. The dimensions of the tobacco leaf edge 156 of the tobacco leaf 150 would be at least equal to, and preferably larger in size than the longitudinal dimension 116 and transverse dimension 118 of the rolling paper substrate 110, as illustrated in FIG. 1. A bonding agent is applied to at least one of the rolling paper substrate bonding surface 114 and the tobacco leaf bonding surface 154, wherein the bonding agent is referred to as a paper applied bonding composition 132 (applied to the rolling paper substrate bonding surface 114) and a tobacco applied bonding composition 134 (applied to the tobacco leaf bonding surface 154). The bonding agent is preferably a non-toxic, tacky material capable of burning. The bonding agent can be flavor-free and/or scent-free to minimize any adverse effects of the bonding agent on the smoking experience. Alternatively, the bonding agent can be enhanced by adding a flavoring and/or scent thereto to enhance the smoking experience.

The paper applied bonding composition 132 and/or tobacco applied bonding composition 134 joins the rolling paper substrate 110 and tobacco leaf 150 together. At any point in the assembly process, the tobacco leaf edge 156 of the tobacco leaf 150 is sized to conform to the outline of the rolling paper substrate 110. The timing of the sizing step is determined by an elected alignment and bonding process. Sizing the tobacco leaf 150 prior to bonding enables the process to utilize the edges for registration between the tobacco leaf 150 and the rolling paper substrate 110. Sizing the tobacco leaf 150 subsequent to bonding enables the process to ensure registration between the tobacco leaf 150 and the rolling paper substrate 110 without an alignment device. In the latter process, the rolling paper substrate 110 can be oversized, where the finished product is sized during singulation. Upon completion of the bonding and sizing steps, the completed laminated rolling paper 100 is packaged in accordance with any suitable packaging process and form factor.

An exemplary process of rolling a smokable product 199 within the laminated rolling paper 100 is illustrated in FIG. 4. The smokable product 199 can be any smokable product, including tobacco, cannabis (where legally consumable), hash, cloves, damiana, and any other legally consumable smokable product in the respective region. The process initiates by preferably placing the laminated rolling paper 100 upon a horizontal surface, orienting the smokable substance receiving surface 112 facing upward. A volume of the smokable product 199 is placed spanning across the smokable substance receiving surface 112 in a transverse direction adjacent to the second longitudinal rolling paper edge 122. Once the smokable product 199 is disbursed across the smokable substance receiving surface 112, the rolling paper substrate 110 is rolled, entrapping the volume of smokable product 199 therein. At some point in the process moisture is applied to the moisture activated gum strip 160, activating the bonding agent. The rolling process continues until the moisture activated gum strip 160 bonds with the roll. Once complete, the rolled cigarette awaits ignition and inhalation. When desired, the user would ignite a distal end of the rolled cigarette and subsequently inhale fumes from the burning rolled cigarette. The user would periodically inhale the fumes emanating from the burning rolled cigarette until the cigarette is significantly depleted.

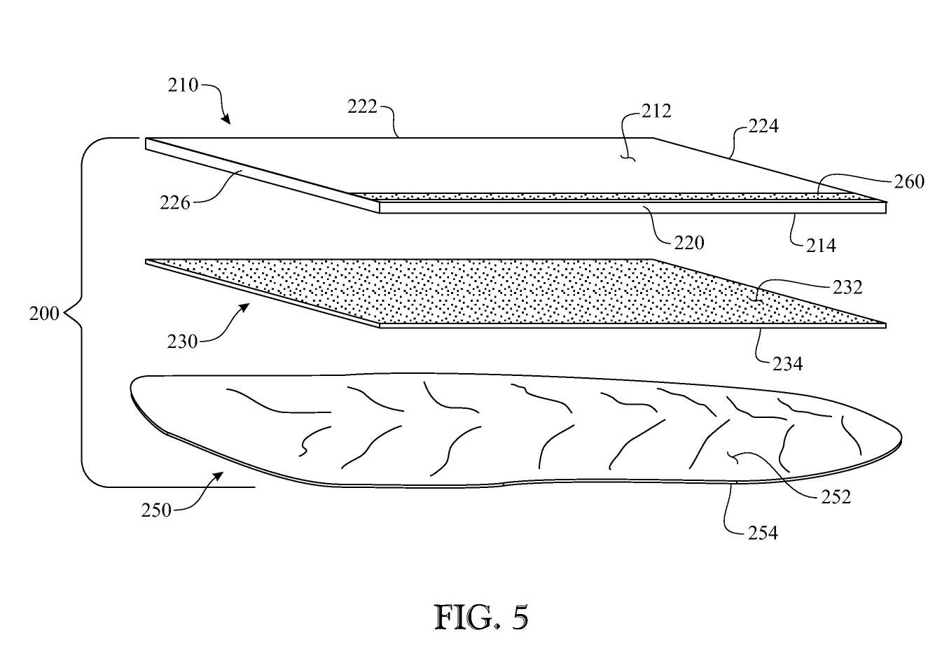

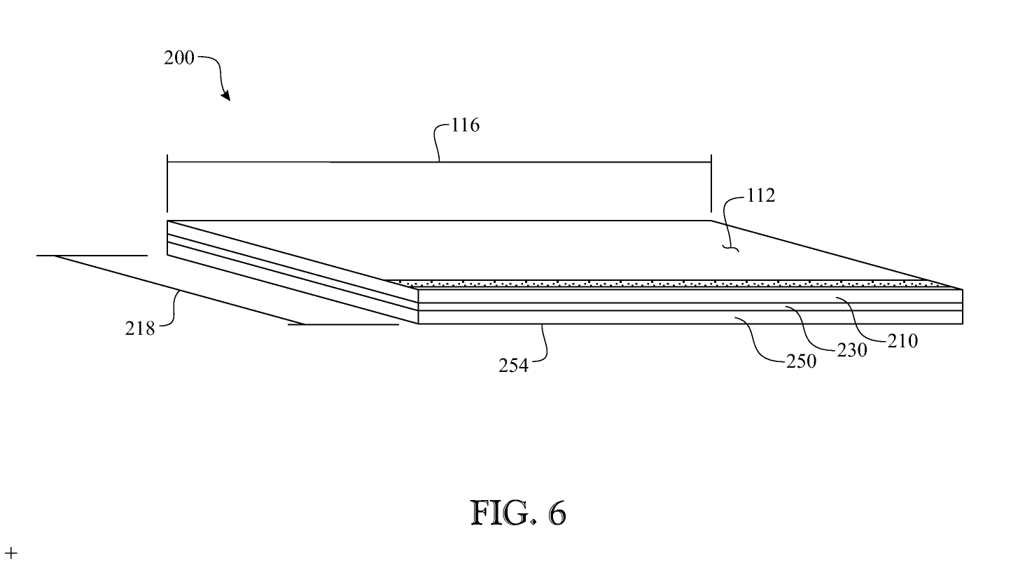

An alternative embodiment, referred to as a laminated rolling paper 200 is illustrated in the exemplary embodiments presented in FIGS. 5 and 6. The laminated rolling paper 200 is a modified version of the laminated rolling paper 100, including a majority of similar elements. Like features of the laminated rolling paper 100 and the laminated rolling paper 200 are numbered the same except preceded by the numeral ‘2’. The primary difference is the laminated rolling paper 200 includes a bonding layer 230, which carries a paper adhering bonding composition 232 disposed upon on a first surface and a tobacco adhering bonding composition 234 disposed upon on a second, opposite surface. The bonding layer 230 is sandwiched between a rolling paper substrate 210 and a tobacco leaf 250. This configuration provides an alternative manufacturing process.

The laminated rolling paper 100, 200 provides significant advantages over currently offered rolling papers. One advantage is the natural smokable product flavor. A second advantage of the laminated rolling paper 100, 200 is the natural texture and feel of a tobacco leaf. A third advantage of the laminated rolling paper 100, 200 is the reduced potential for damage compared to a tobacco leaf.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. A laminated rolling paper comprising:
a first rolling paper substrate sized, shaped, and of a weight consistent with established rolling paper properties;
a second rolling paper substrate fabricated of a natural, smokable product; and
a bonding composition,
wherein the first rolling paper substrate and the second rolling paper substrate are laminated by the bonding composition.

2. A laminated rolling paper as recited in claim 1, said ####.

3. A rolling paper and packaging configuration combination as recited in claim 1, wherein each of said series of individual compartments are sealed under a vacuum and void of moisture and air.

4. A rolling paper and packaging configuration combination as recited in claim 1, wherein at least one of said first wrapper and said second wrapper is fabricated of a one of a translucent and transparent material.

5. A rolling paper and packaging configuration combination as recited in claim 1, wherein said bonded edges are at least one of:
thermally bonded,
ultrasonically bonded, and
adhesively bonded.

6. A rolling paper and packaging configuration combination as recited in claim 1, wherein at least one of said first wrapper and said second wrapper is fabricated of at least one of:
a metallic material,
a foil material,
a plastic material,
a Mylar material, and
an aluminum material.

7. A rolling paper and packaging configuration combination as recited in claim 1, said rolling paper substrate is fabricated of one of:
wood pulp,
hemp,
flax,
rice straw,
a tobacco leaf, and
esparto.

8. A rolling paper and packaging configuration combination as recited in claim 1, the series of individual compartments are arranged in one of the following configurations:
a rolled configuration, and
an accordion configuration.

9. A rolling paper and packaging configuration combination as recited in claim 1, each rolling paper substrate further comprising an adhesive applied to at least a portion of one surface of said rolling paper substrate.

10. A rolling paper and packaging configuration combination comprising:
an individual sheet of a rolling paper substrate, wherein said rolling paper substrate is characterized for use in rolling a smokable product into a form of a cigarette;
a first wrapper fabricated of a moisture impervious material bound by a first elongated edge and a second elongated edge, wherein said first elongated edge and said second elongated edge are parallel to one another;
a second wrapper fabricated of a moisture impervious material bound by a first elongated edge and a second elongated edge, wherein said first elongated edge and said second elongated edge are parallel to one another;
said individual sheet of rolling paper is positioned between said first wrapper and said second wrapper; and
said first elongated edge of said first wrapper and said first elongated edge of said second wrapper are hermetically sealed to one another;
said second elongated edge of said first wrapper and said second elongated edge of said second wrapper are hermetically sealed to one another; and
said first wrapper and said second wrapper are hermetically sealed to one another along a transverse direction at each end thereof sealing said sheet of rolling paper substrate within a resulting individual compartment.

11. A rolling paper and packaging configuration combination as recited in claim 10, wherein said individual compartment is sealed under a vacuum and void of moisture and air.

12. A rolling paper and packaging configuration combination as recited in claim 10, wherein at least one of said first wrapper and said second wrapper is fabricated of a one of a translucent and transparent material.

13. A rolling paper and packaging configuration combination as recited in claim 10, further comprising:
a plurality of sheets of rolling paper, each sheet of rolling paper packaged in a respective individual compartment formed by a respective first wrapper and second wrapper; and
a rolling paper carton comprising a plurality of sides forming a carton interior volume,
wherein said plurality of individually packaged sheets of rolling paper are inserted within said carton interior volume.

14. A rolling paper and packaging configuration combination as recited in claim 10, wherein said bonded edges are at least one of:
thermally bonded,
ultrasonically bonded, and
adhesively bonded.

15. A rolling paper and packaging configuration combination as recited in claim 10, wherein at least one of said first wrapper and said second wrapper is fabricated of at least one of:
a metallic material,
a foil material,
a plastic material,
a Mylar material, and
an aluminum material.

16. A rolling paper and packaging configuration combination as recited in claim 10, said rolling paper substrate is fabricated of one of:
wood pulp,
hemp,
flax,
rice straw,
a tobacco leaf, and
esparto.

17. A rolling paper and packaging configuration combination as recited in claim 10, said rolling paper substrate further comprising an adhesive applied to at least a portion of one surface of said rolling paper substrate.
